(19) United States
(12) Patent Application Publication
(10) Pub. No.: US 2015/0142496 A1
(43) Pub. Date: May 21, 2015

(54) HYDROCARBON MATRIX SYSTEM AND METHOD OF USING SAME

(71) Applicant: SHELL OIL COMPANY, Houston, TX (US)

(72) Inventors: Saskia Karolina KAPINGA, The Hague (NL); Andrei KOTOV, The Hague (NL); Siok Lian Nina LIEM, The Hague (NL)

(73) Assignee: SHELL OIL COMPANY, Houston, TX (US)

(21) Appl. No.: 14/086,630

(22) Filed: Nov. 21, 2013

(51) Int. Cl. G06Q 10/06; E21B 43/00; G06Q 50/06

(52) U.S. Cl. CPC G06Q 10/06313; G06Q 50/06; E21B 43/00
USPC 705/7.23

(57) ABSTRACT

A matrix system for performing hydrocarbon operations involving exploration, production, transportation, and delivery of hydrocarbons. The matrix system includes a matrix unit, a user terminal, a tag, and a gatekeeper. The matrix unit includes a multi-dimensional matrix including bins to receive hydrocarbon materials, with fields including rows, columns, levels, and themes. Each bin corresponds to one of the rows, columns, levels, and themes. The user terminal includes a user input to upload the hydrocarbon materials to the matrix unit and a user output to receive the hydrocarbon materials from the matrix. The tag is operatively connectable to the hydrocarbon materials. The gatekeeper includes reviewers to review the hydrocarbon materials and to define access criteria and the plurality of fields for each of the tags, and a system custodian to selectively apply the tag to the hydrocarbon materials based on the review whereby the hydrocarbon materials are selectively accessible by users.

### BACKGROUND

The present disclosure relates generally to hydrocarbon operations. More specifically, the present disclosure relates to techniques involving hydrocarbon operations, such as the exploration, production, transportation, and delivery of natural gas.

Exploration may be used to locate valuable hydrocarbons, such as oil and gas. Wellbores may be drilled into the earth to access and produce such hydrocarbons. Production equipment may be used to extract the hydrocarbons to the surface. Transportation equipment, such as carriers and/or trucks, may be used to convey the hydrocarbons to locations for delivery. Hydrocarbons may be delivered to interim processors and/or end users for consumption. These and other operations used in connection with hydrocarbons.

During various hydrocarbon operations, data may be gathered concerning various stages of the hydrocarbon operations. The data may be used to analyze the hydrocarbon operations and/or to make decisions. For example, measurements may be taken of subsurface formations, hydrocarbons produced, and/or equipment operation. The measurements may be used to determine, for example, operating parameters, well plans, equipment specifications, and/or hydrocarbon composition. The data may be reviewed by various personnel, such as operators, business management, etc.

Databases and software may be used to collect the data and perform calculations using the data. Examples of techniques using data are provided in US patent/application Nos. U.S. Pat. Nos. 8,510,015, 7,171,426, and 20090149981.

### SUMMARY

In at least one aspect, the disclosure relates to a matrix system for performing hydrocarbon operations. The hydrocarbon operations comprise at least one of exploration, production, transportation, and delivery of hydrocarbons. The matrix system includes a matrix unit, at least one user terminal, a tag, and a gatekeeper. The matrix unit comprises a multi-dimensional matrix comprising bins to receive hydrocarbon materials, and has a plurality of fields. The fields include rows, columns, levels, and themes. Each of the bins corresponds to one of the rows, columns, levels, and themes. The terminal is operatively connectable to the matrix unit, and includes a user input to upload the hydrocarbon materials to the matrix unit and a user output to receive hydrocarbon materials from the matrix. The tag is operatively connectable to each of the hydrocarbon materials. The gatekeeper is operatively connectable to the matrix unit, and includes reviewers and a system custodian. The reviewers review the hydrocarbon materials and define access criteria and fields for each of the tags. The system custodian selectively applies the tag to the hydrocarbon materials based on the review whereby the hydrocarbon materials are selectively accessible by users.

In another aspect, the disclosure relates to a method for performing hydrocarbon operations. The hydrocarbon operations include at least one of exploration, production, transportation, and delivery of hydrocarbons. The method involves receiving hydrocarbon materials from at least one user into a matrix unit. The matrix unit includes a multi-dimensional matrix comprising bins to receive hydrocarbon materials, and has a plurality of fields. The fields include rows, columns, levels, and themes. Each of the bins corresponds to one of the rows, columns, levels, and plurality of themes. The method also involves operatively connecting a tag to each of the hydrocarbon materials, and selectively providing access to the hydrocarbon materials to users by reviewing the hydrocarbon materials with a plurality of reviewers. The method also involves defining access criteria and fields for each of the tags based on the reviewing, assigning the hydrocarbon materials to the matrix based on the fields, and selectively displaying the tagged hydrocarbon materials in the matrix based on the access criteria.

### BRIEF DESCRIPTION OF THE DRAWINGS

A more particular description of the disclosure, briefly summarized above, may be had by reference to embodiments thereof that are illustrated in the appended drawings. It is to be noted, however, that the appended drawings illustrate example embodiments of this disclosure and are, therefore, not to be considered limiting of its scope. The figures are not necessarily to scale, and certain features and certain views of the figures may be shown exaggerated in scale or in schematic in the interest of clarity and conciseness.

FIG. 1 is a schematic diagram depicting hydrocarbon operations and a matrix system usable for performing the hydrocarbon operations.

FIGS. 2A-2D are schematic diagrams depicting various gas operations.

FIG. 3 is a schematic diagram depicting the matrix system.

FIGS. 4A and 4B are schematic diagrams depicting example matrices usable with the matrix system.

FIG. 5 is a schematic diagram depicting selection of hydrocarbon materials from the matrix.

FIG. 6 is a schematic diagram depicting identification of hydrocarbon materials using the matrix system.

FIG. 7 is a schematic diagram depicting review of hydrocarbon materials using the matrix system.

FIG. 8 is a schematic diagram depicting content selection using the matrix system.

FIG. 9 is a schematic diagram depicting content retrieval using the matrix system.

FIG. 10 is a schematic diagram depicting a matrix operation using the matrix system.

FIG. 11 is a flow chart depicting a method of performing hydrocarbon operations.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

A matrix system and method is provided for performing hydrocarbon operations. ‘Hydrocarbon operations’ as used herein refers to exploration, production, transportation, delivery of hydrocarbons (e.g., natural gas or liquid natural gas (LNG)) and associated activities used in support thereof. The matrix system includes a multi-dimensional matrix with bins to receive and store hydrocarbon materials. ‘Hydrocarbon materials’ as used herein may refer to materials, such as logs, photos, presentations, videos, files, and/or other information, relating to the hydrocarbon operations. A gatekeeper may be provided to tag the materials according to fields (e.g., rows, columns, levels, themes, etc.) of the matrix, and/or to selectively define access to the tagged hydrocarbon materials.

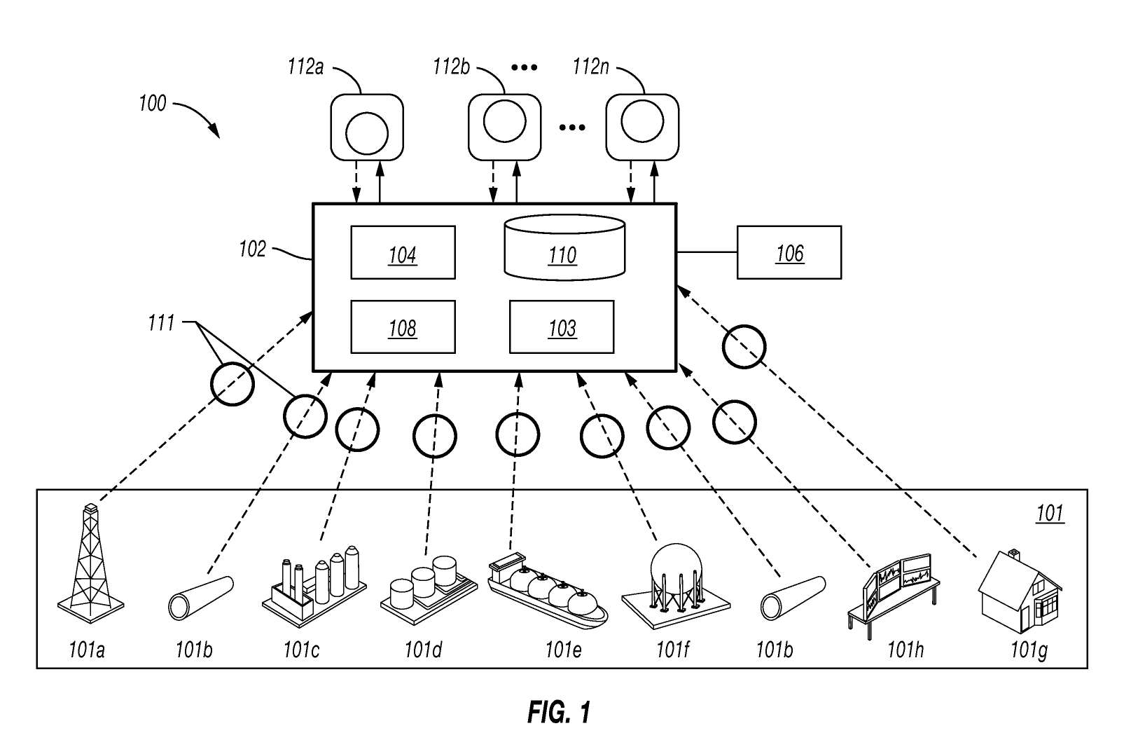

FIG. 1 is a schematic diagram depicting a matrix system 100 for performing hydrocarbon operations 101 using a hydrocarbon matrix unit 102. FIG. 1 depicts a variety of hydrocarbon operations 101 operatively coupled to the hydrocarbon matrix unit 102, and accessed by users 112a-n.

The hydrocarbon operations 101 may include, for example, onshore production 101a, piping 101b, treatment and liquefaction 101c, storage and loading 101d, shipping 101e, unloading re-gas 101f, consumer 101g, and marketing and trading 101h. The various hydrocarbon operations 101 may provide hydrocarbon materials 111 to the matrix unit 102. Users 112a-n are depicted in communication with the matrix unit 102. As shown, the users 112a-n may input hydrocarbon information 111 to the matrix unit 102 and/or receive hydrocarbon information 111 from the matrix unit 102. The users 112a-n may be positioned at one or more of the hydrocarbon operations 101 and/or at other locations.

The matrix unit 102 may be used by one or more users 112a-n to receive hydrocarbon materials 111 concerning the hydrocarbon operations 101 and/or to provide hydrocarbon materials 111 that may relate to or affect the hydrocarbon operations 101. The users 112a-n may be one or more individuals performing various aspects of the hydrocarbon operations 101 based on the hydrocarbon materials 111 received therefrom. The users 112a-n may access the matrix unit 102 via terminals, interfaces, browsers, Ethernet, connections, internet, and/or other means.

The matrix unit 102 includes a matrix 104, an activator 108, electronics 103, and a storage container 110. The matrix unit 102 may include hardware and/or software (e.g., server, processer, etc.) used to support the matrix 104 and the selective accessibility of hydrocarbon materials 111 contained therein. The matrix 104 may include software and/or hardware (e.g., pixels, monitors, graphical interface units (GUIs), and associated devices) to arrange and/or display the hydrocarbon materials 111.

A gatekeeper 106 is coupled to the matrix unit 102 for operation therewith. The gatekeeper 106 may include individuals, hardware, and/or software (e.g., terminals, interfaces, browsers, Ethernet, etc.) capable of receiving and/or reviewing the hydrocarbon materials 111. The gatekeeper 106 may be used to review hydrocarbon materials 111 received by the matrix unit 102, to identify and/or tag the hydrocarbon materials 111, and/or to selectively make certain hydrocarbon materials 111 accessible to one or more of the users 112a-n.

The activator 108 may be provided with hardware and/or software (e.g., controllers, transceivers, processors, etc.) for selectively activating one or more of the hydrocarbon operations based on the hydrocarbon materials 111. The users 112a-n may access the hydrocarbon materials 111 and request the activator 108 to perform certain of the hydrocarbon operations 101 based on the hydrocarbon materials 111 received from the matrix 104. The activator 108 may be provided with software to perform analyses of the hydrocarbon materials 111 and send them to the users 112a-n. The activator 108 may also automatically send commands to the hydrocarbon operations 101 to perform various functions associated therewith.

The electronics 103 may include electronic hardware (e.g., transceivers, microprocessors, central processing unit (CPU), etc.) used for communication, storage, processing, analysis, and other operations associated with the matrix system 100. For example, the electronics 103 may be provided with means for communicating and/or transporting the hydrocarbon materials 111 between sources, such as the hydrocarbon operations 101, the gatekeeper 106, and/or users 112a-n. The storage unit 110 may include one or more hardware or software devices (e.g., containers, files, folders, databases, memory, disk storage, RAM, etc.) for performing matrix operations, such as receiving, communicating, and storing, the hydrocarbon materials 111.

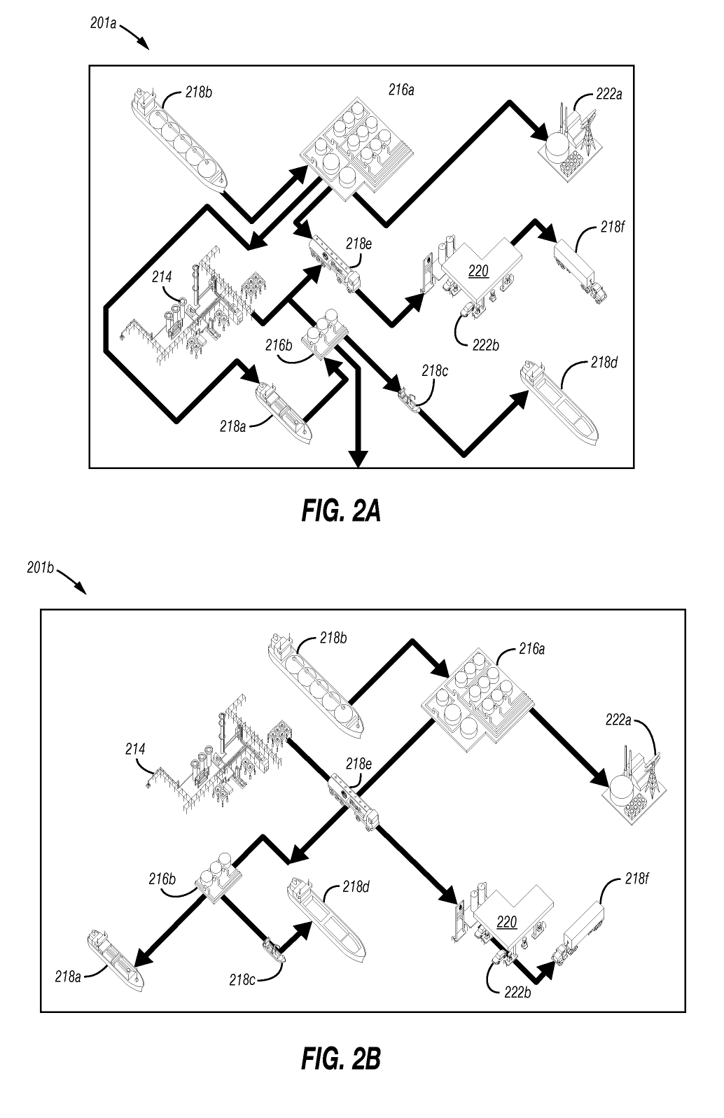

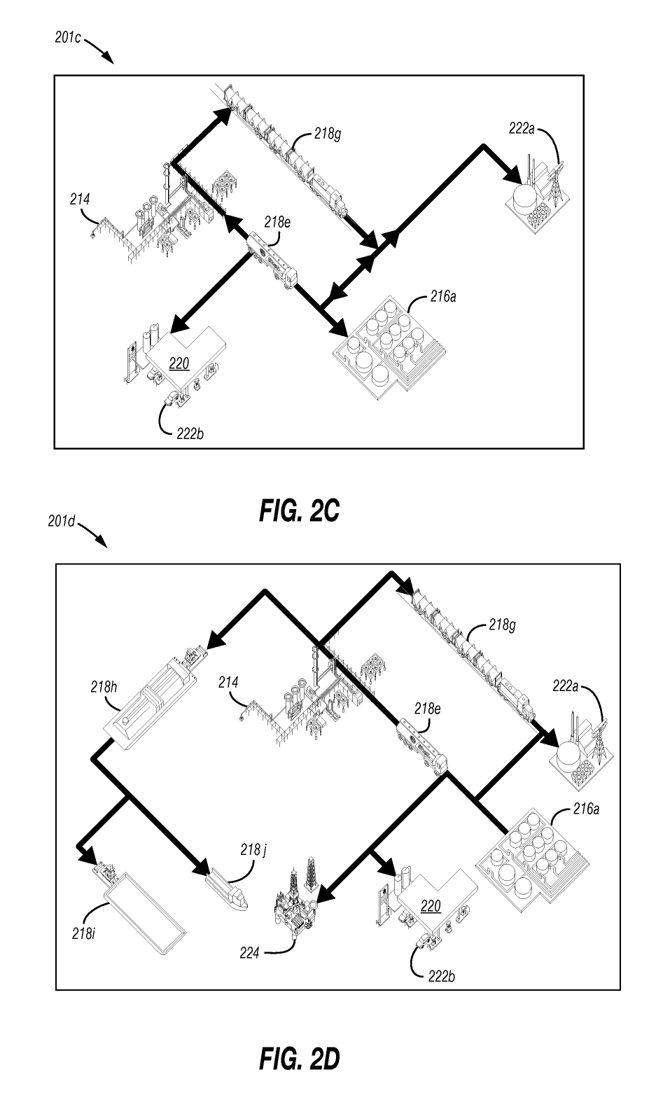

FIGS. 2A-2D depict hydrocarbon operations 201a-d usable with the matrix unit 102. As shown in these views, the hydrocarbon operations 101 of FIG. 1 may be gas operations 201a-d used to produce, transport and deliver natural gas. In the examples shown, the gas operation 201a includes liquefaction 214 (e.g., small scale), terminals 216a,b, transporters 218a-i (e.g., carriers, vessels, trucks, trailers, trains, barges, boats), and distributors 220. Receivers 222a,b, such as power plants and consumers, are depicted as receiving gas. A rig 224 may also be provided for producing and/or storing hydrocarbons. Hydrocarbons may be passes between the various portions of the hydrocarbon operations 201a-d as indicated by the arrows.

The matrix system 102 of FIG. 1 may be used by users 112a-n to collect hydrocarbon materials concerning the operations of FIGS. 2A-2D, and for performing hydrocarbon operations 101 associated therewith. For example, users may upload hydrocarbon materials 111 concerning gas operations 201a-d, such as production quantities, transportation costs and delivery schedules, and access hydrocarbon materials of other users that may be usable in making decisions concerning the gas operations 201a-d. The user and/or the activator 108 may be used to implement the decisions and adjust the hydrocarbon operations 201a-d based on the accessed hydrocarbon materials alone or in combination with other information.

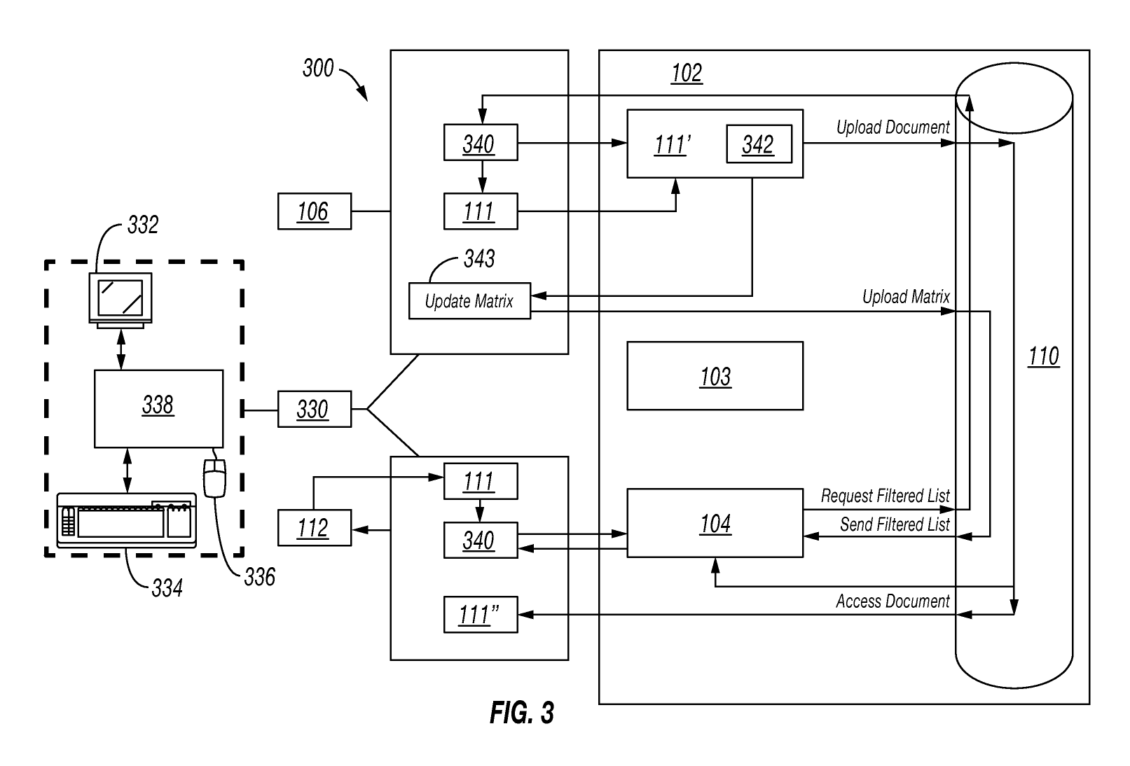

FIG. 3 is a schematic diagram depicting an operational view 300 of a matrix system (e.g., 100 of FIG. 1). FIG. 3 shows operations between user 112 (which may be one or more of the users 112a-n of FIG. 1), the gatekeeper 106, and the matrix unit 102. The matrix unit 102 may be accessible to the user 112 and the gatekeeper 106 by terminals (e.g., interface, I/O) 330.

The terminals 330 may provide access to the matrix unit 102 as indicated by the arrows. The terminals 330 may act as an input for uploading hydrocarbon materials 111 and/or an output for downloading hydrocarbon materials. As shown in the detail of terminal 330, the terminals 330 may include various equipment, such as a monitor 332, keyboard 334, mouse 336, and other electronics 338 (e.g., transceivers, processor, memory, power, etc.), usable for operation with the matrix unit 102. In the example shown, the user 112 and gatekeeper 106 may employ a browser 340 to access the matrix unit 102 via a communication link (e.g., internet).

The matrix system 300 may operate in a networked environment using logical connections to one or more remote computers, such as the terminals 330. Terminals 330 may each be a personal computer, a server, a router, a network PC, a peer device or other common network node. The links depicted as arrows in FIG. 3 may be internet, intranet, networked, a local area network (LAN) and/or a wide area network (WAN) connections. Associated interfaces, modems (internal and/or external), links, adapters, and/or other means for establishing communications may be provided. It will be appreciated that the network environment shown is exemplary and other means of establishing communications may be used.

As shown in FIG. 3, user 112 is coupled to the matrix unit 102 for passing hydrocarbon materials 111 to the matrix unit 102. As also shown by the diagram, the user 112 may upload the hydrocarbon materials 111 to the matrix 104 using the browser 340. The uploaded hydrocarbon materials 111 may be stored in database 110. The uploaded hydrocarbon materials 111 are accessible by the gatekeeper 106 for review.

The gatekeeper 106 is coupled to the matrix unit 102 for reviewing and tagging the hydrocarbon materials 111, and updating the matrix 104. The gatekeeper 106 receives the uploaded hydrocarbon materials 111 via browser 340, and reviews them for various criteria. The gatekeeper 106 may consider the content, subject matter, specifications and other considerations in evaluating the uploaded hydrocarbon materials 111.

Based on pre-determined criteria and/or an evaluation, the hydrocarbon materials 111 may be provided with a tag 342 (e.g., metatag) by the gatekeeper 106 as schematically depicted. The tag 342 may be used to categorize and/or identify the hydrocarbon materials 111 and/or features thereof according to the preexisting criteria. For example, the tag 342 may provide the hydrocarbon materials 111 with one or more fields relating to time, location, type, etc. Once tagged, the gatekeeper 106 may submit the hydrocarbon materials 111 to the storage unit 110 as tagged hydrocarbon materials 111′. The tagged hydrocarbon materials 111′ may be received into the matrix 104 according to the tags 342.

Based the on pre-determined criteria, the gatekeeper 106 may also tag that part or all of the hydrocarbon materials 111 as accessible hydrocarbon materials 111″ for access by the users 112. Accessibility may be defined based on various user criteria, such as content, identification, job category, function, status, etc. The gatekeeper may also update the matrix 104 to receive the hydrocarbon materials 111″ as indicated by box 343. The user 112 may use the browser 340 to search the matrix 104 for certain of the tagged hydrocarbon materials 111′, and access selected of the accessible hydrocarbon materials 111.″

The matrix unit 102 may be used to support the exchange of selected hydrocarbon materials 111, 111′, 111″ between users 112 and the gatekeeper 106. The matrix unit 102 may also be used to support the matrix 104 for receiving, storing, and selectively providing the hydrocarbon materials 111, 111′, 111″. The matrix 104 presents the accessible hydrocarbon materials 111″ to the user 112 in an arrangement according to the tags 342. The matrix 104 may be displayed by the monitor 332 in an interactive graphical user interface. The user 112 may use the terminal 330 to interact with the matrix.

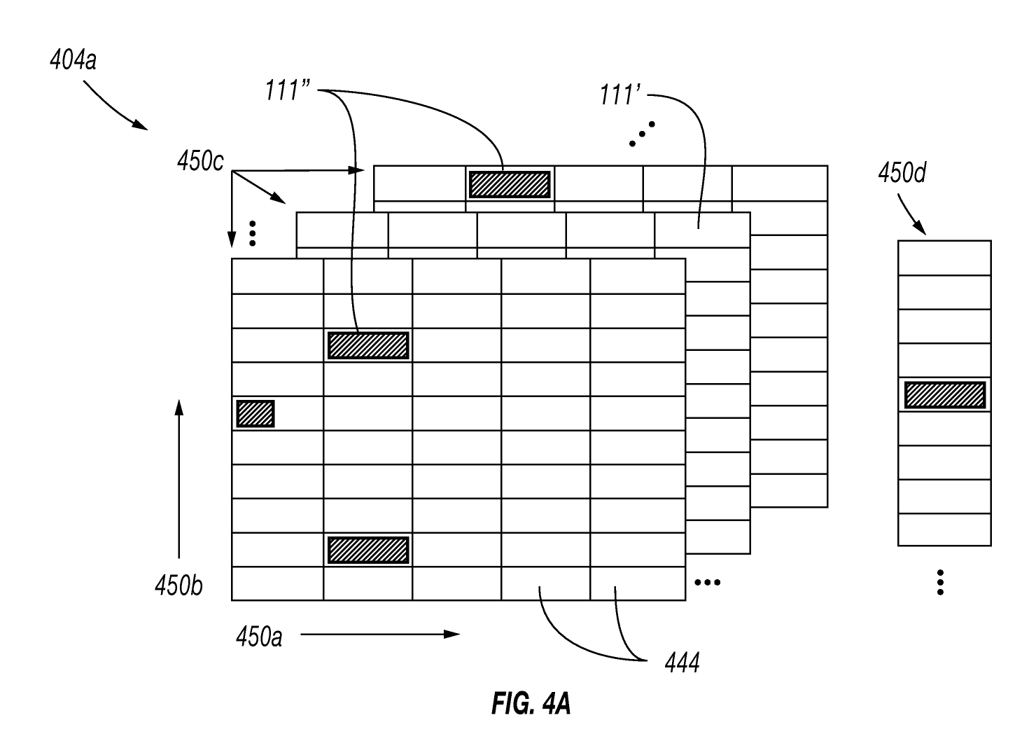

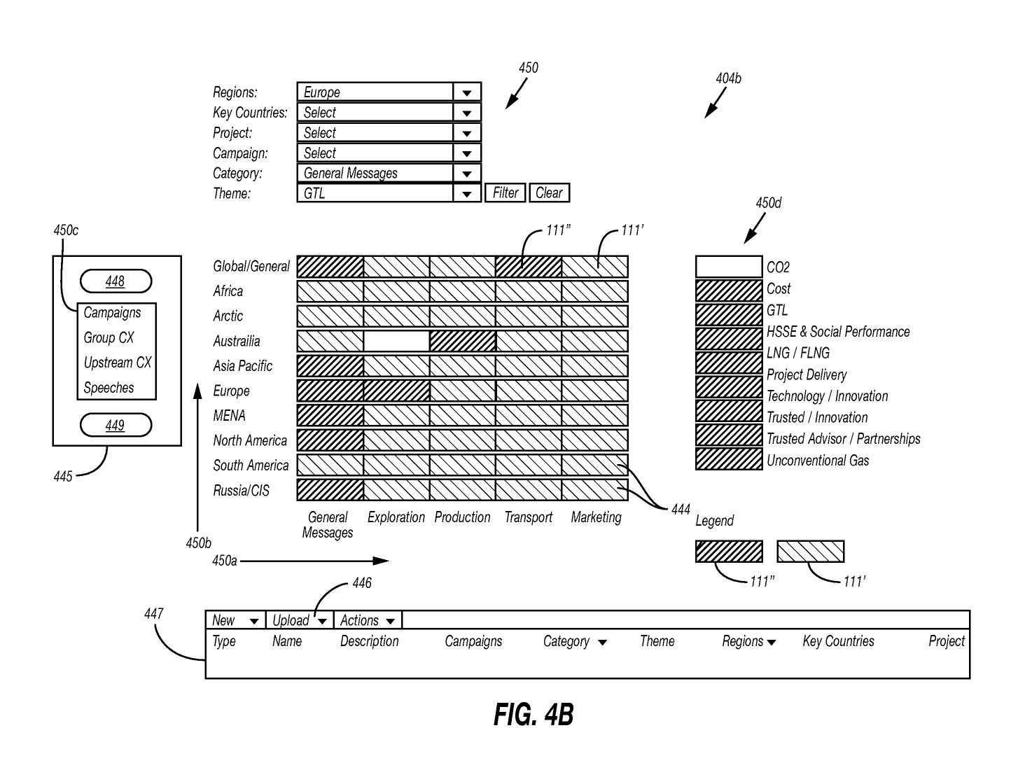

FIGS. 4A and 4B are schematic diagrams of hydrocarbon matrices 404a,b for receiving and storing the hydrocarbon materials, such as hydrocarbon materials 111′, 111″ of FIG. 3. The hydrocarbon matrix 400a includes bins 444 arranged in columns 450a, rows 450b, levels 450c, and themes 450d, collectively referred to as fields 450. Fields 450 are shown as selectable using drop down menus. Each of the columns 450a, rows 450b, levels 450c, and themes 450d relate to a bin 444 within the matrix 404a. Each bin 444 may be positioned in columns 450a, rows 450b, levels 450c, and themes 450d according to the fields 450 as provided in tags 342 (FIG. 3). Each bin 444 may include one or more sub-bins.

In an example, the columns 450a may relate to types (e.g., exploration, production, general, etc.; see, e.g., types shown in FIGS. 1A-2C), the rows 450b may relate to locations (e.g., continent, country, well, etc.), the levels 450c may refer to other categories (e.g., regions, projects, campaigns, categories, themes, etc.), the themes 450d may relate to function (e.g., gas, finances, delivery, technology, CO2, etc.) The bins 444 may include fields 450, such as regions, categories, themes, campaigns, and projects. For example, regions, may correspond with rows 450a, category, may correspond with columns 450b, and theme 450d may correspond with a separate column.

The bins 444 are configured to receive the hydrocarbon materials 111′, 111″. Part, or all of, the hydrocarbon materials 111′, 111″ may be placed in one or more bins 444. The same hydrocarbon material 111′, 111″ may be placed in more than one bin 444. One or more of the bins 444 may have no accessible hydrocarbon materials 111″ as indicated by color and/or pattern, or contain accessible hydrocarbon materials 111″ as indicated by a different color and/or pattern.

FIG. 4B shows an example hydrocarbon matrix 404b displayed for a user. As shown, the matrix 404b includes rows 450a (locations including global/general, Africa, Arctic, Australia, Asia Pacific, Europe, Middle East—MENA, North America, South America, Russia/CIS), columns 450b (functions including general messages, exploration, production, transport, and marketing), levels 450c (including campaigns, group, upstream, speeches), and themes 450d (including CO2, Cost, GTL, Safety (HSSE) & Social Performance, LNG/FLNG, project delivery, technology/innovation, trusted advisor/partnerships, unconventional gas).

The matrix 104 also includes a matrix key 446 to allow the user to perform functions relating to the matrix 104. For example, the matrix key 446 may provide the user with the ability to provide hydrocarbon materials 111 for upload to the matrix 404b, search the hydrocarbon materials 111″, and/or request additional criteria for the matrix 404b. Other function keys 445 may also be provided, such as a search key 448 for searching the hydrocarbon materials 111″ and a trash key 449 for discarding hydrocarbon materials. The matrix 104 also includes a results display 447 for displaying highlighted and/or searched hydrocarbon materials 111.″

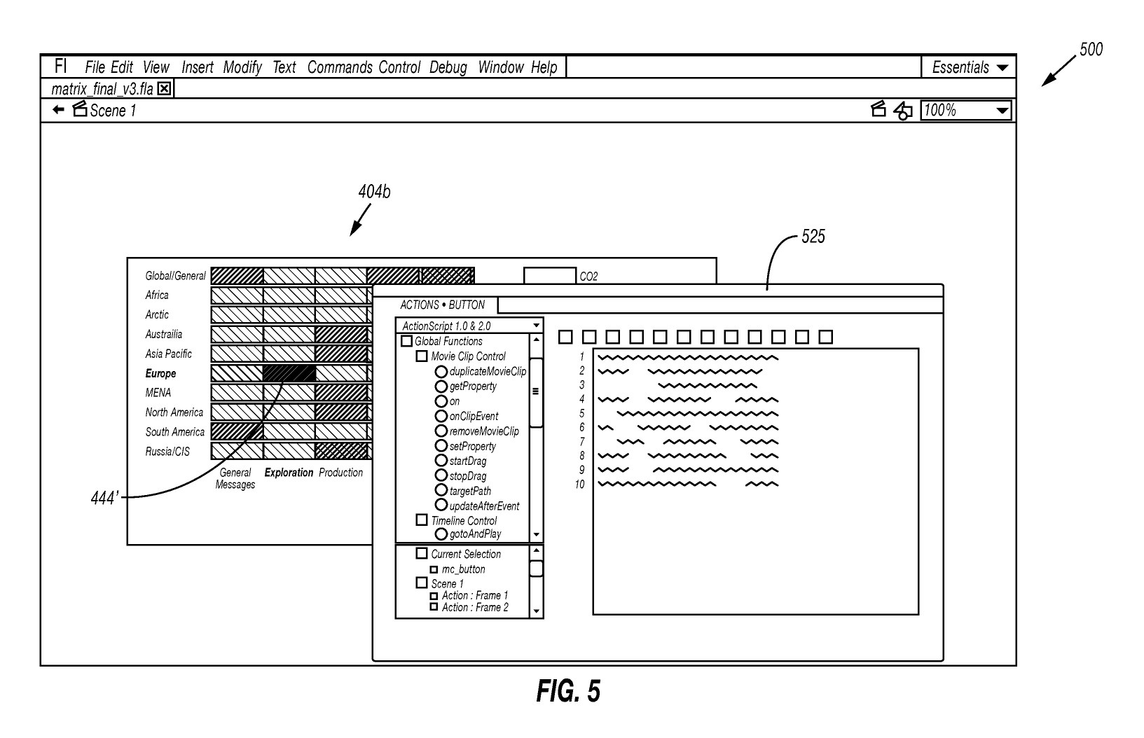

Referring to FIGS. 4B and 5, the matrix 404a may be interactively accessed by a user (e.g., 112 of FIG. 3). The user 112 may select one or more bins 444 using, for example, terminal 330 of FIG. 3. The bins 444 may be highlighted, for example, when a cursor passes over the bin 444 using a mouse (e.g., 336). Highlighted bins 444′ may be presented to the user 112, for example, on the results display 447 according to the categories corresponding to the row 450a and column 450b in which the highlighted bin 444′ appears.

The highlighted bin 444′ may be mapped in the matrix 404b according to the column 450a, row 450b, and level 450c corresponding to the highlighted bin 444′. For example, the highlighted bin 444′ may correspond to a given column labeled Europe and a given row labeled Regions. Additional criteria, such as theme 450d or other fields 450, may be selected to further limit the results. Additional filters or restrictions may be defined. The user may flip through fields 450 using, for example, drop-down menus.

FIG. 5 shows a screenshot 500 depicting the matrix 404b and the corresponding code used to highlight the selected bin 444.′ As shown in this view, the highlighted bin 444′ may be defined by specified criteria, such as hover, color, fields, etc. as indicated by the selection screen 525

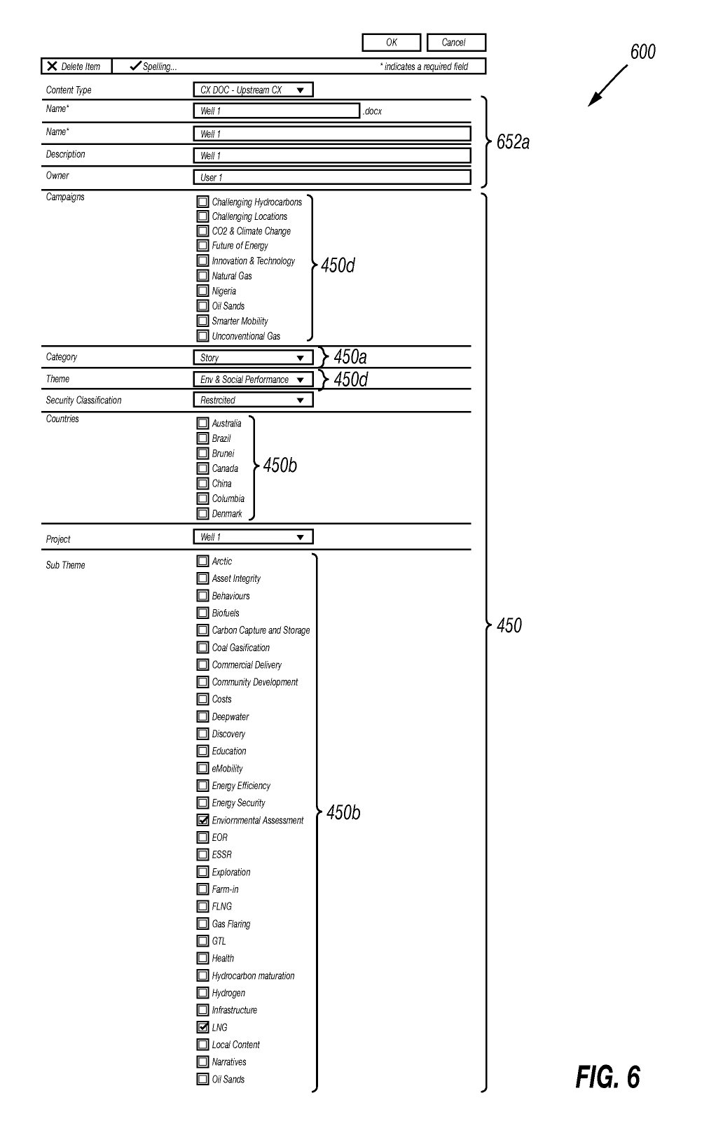

FIG. 6 depicts identification 600 of hydrocarbon materials 111 for upload onto the matrix 404b (FIGS. 4B-5). This figure shows the selection of fields 450 for the hydrocarbon materials 111 to be uploaded. The fields may include, for example, content type, name, title, description, owner, campaign, category, theme, security classification, countries, project, and subtheme.

A variety of fields may be provided for the hydrocarbon materials 111. Some of the fields, such as name, title, description and owner, may be defined for basic fields 652a of the hydrocarbon material 111. Some of the fields, such as campaign, category, theme, security classification, countries, and projects or arctic, asset integrity, behaviors, biofuels, may be used as matrix criteria 652b, such as rows 450a, columns 450b, themes 450c, and levels 450d, for placement of the hydrocarbon materials 111 in the matrix 404b. Certain information may also be provided that may or may not correlate to a bin 444 in matrix 404b.

Referring to FIGS. 3 and 6, the user 112 and/or gatekeeper 106 may apply part or all of the fields to the hydrocarbon materials 111. The user 112 may select certain fields, such as project name, owner, etc. upon entry of the hydrocarbon information 111. The gatekeeper 106 may apply and/or adjust fields of the hydrocarbon materials. The hydrocarbon materials 111 may be uploaded to the matrix unit 102 for receipt by the gatekeeper 106 as shown in FIG. 3.

Once uploaded, the hydrocarbon information 110 may be placed in the database 110 for access by the gatekeeper 106. The gatekeeper 106 may receive an alert of the entry of the new hydrocarbon material 111. The gatekeeper 106 may review, edit, and/or add fields to the hydrocarbon material 111. The hydrocarbon material 111 may be tagged with the fields as tagged hydrocarbon material 111′ with the tag 342 and/or accessible hydrocarbon materials 111.″

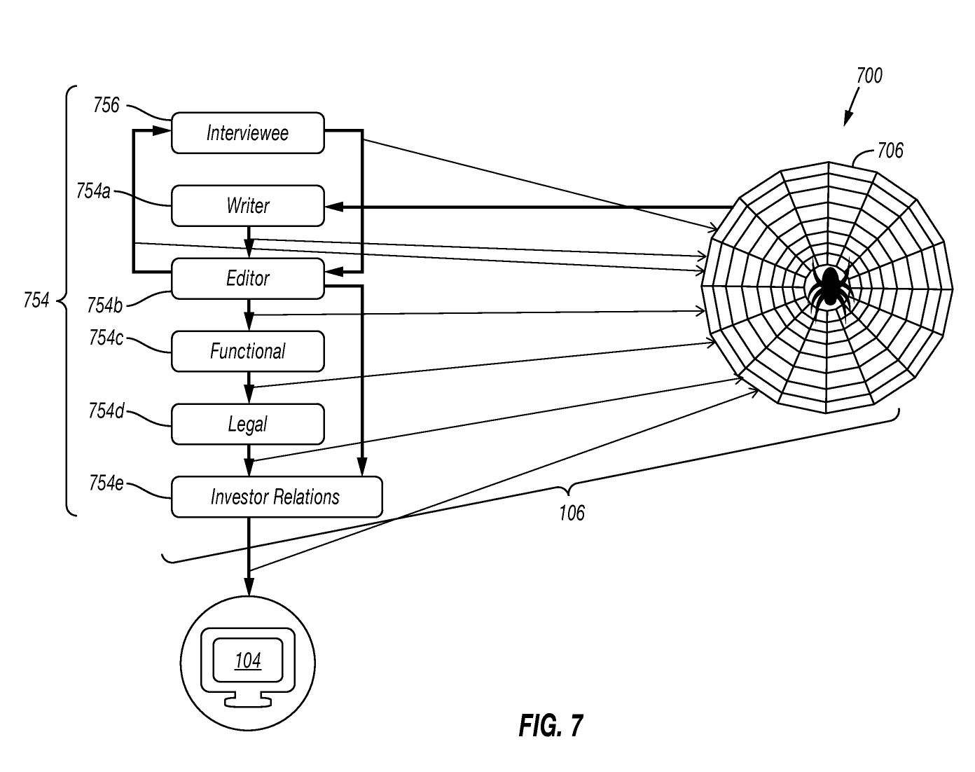

FIG. 7 is a schematic diagram 700 depicting review of the hydrocarbon materials receivable by matrix unit 102, and depicting the function of the gatekeeper 106 of FIG. 3. As shown in this view, the gatekeeper may include a system custodian 706 and one or more individuals reviewers 754 to create and/or review the hydrocarbon materials 111 for upload to the matrix 104. The reviewers 754 may provide various criteria and/or approvals concerning the hydrocarbon materials 111. The reviewers 754 may include, for example, a writer 754a, editor 754b, functional representative 754c, legal representative 754d, and investor relations representative 754e.

The various reviewers 106 may interact with an interviewee 756 which may or may not be the user 112 that uploaded the hydrocarbon materials 111. Each of the reviewers 754 may provide input concerning the hydrocarbon materials 111 to further define fields and/or to make decisions concerning access to one or more users. The reviewers 754 may also adjust the hydrocarbon materials 111 before permitting access. For example, the writer 754a may add or change content, the editor 754b may edit the content, the functional representative 754c may add related content, the legal representative 754c may restrict release of certain materials, and the investor relations representative 754d may adjust the presentation of the materials. These and other adjustments may be provided by the reviewers and/or the gatekeeper 106.

The system custodian 706 may manage the review process. The system custodian 706 may communicate with the various reviewers 754 and interviewee 756 to process the hydrocarbon materials 111 through the review process. The system custodian 706 may also define the review criteria and/or the process. For example, the custodian 706 may set up optional authorities for implementation by the writer 754a.

In an example, the system custodian 706 initiates the review process by sending a system choice of the reviewers 754 as the authorities for review of the hydrocarbon materials. The system choice is delivered to the writer 754a for creation and/or adjustment of the hydrocarbon materials 111. The writer passes the hydrocarbon materials 111 to the editor 754b for review. The editor 754b edits the hydrocarbon materials 111 and forwards notification to the interviewee 756. The editor 754b and interviewee 756 send notifications back and forth until the hydrocarbon materials 111 are finalized and accepted.

Once review with the interviewee 756 is complete, the editor 754b sends the hydrocarbon materials 111 to the investor relations representative 754e, and the functional representative 754c. The functional representative 754c reviews and passes the hydrocarbon materials to the legal representative 754d, and the legal representative 754d reviews and passes the hydrocarbon materials to the investor relations representative 754e.

Each of the reviewers 754a-e and the interviewee 756 may communicate the hydrocarbon materials during review by review notification (e.g., email). Each of the reviewers 754a-e and the interviewee 756 sends archival notification (e.g., archival email) to the system custodian 706 upon completion of their review. Once all reviewers 754 approve, the hydrocarbon materials 111 may be passed to the matrix 104. The custodian 706 may tag the final version of the hydrocarbon materials 111, 111′, 111″ according to the reviews provided and access defined by the reviewers 754, and upload the approved hydrocarbon materials to the matrix 104 for access to select users.

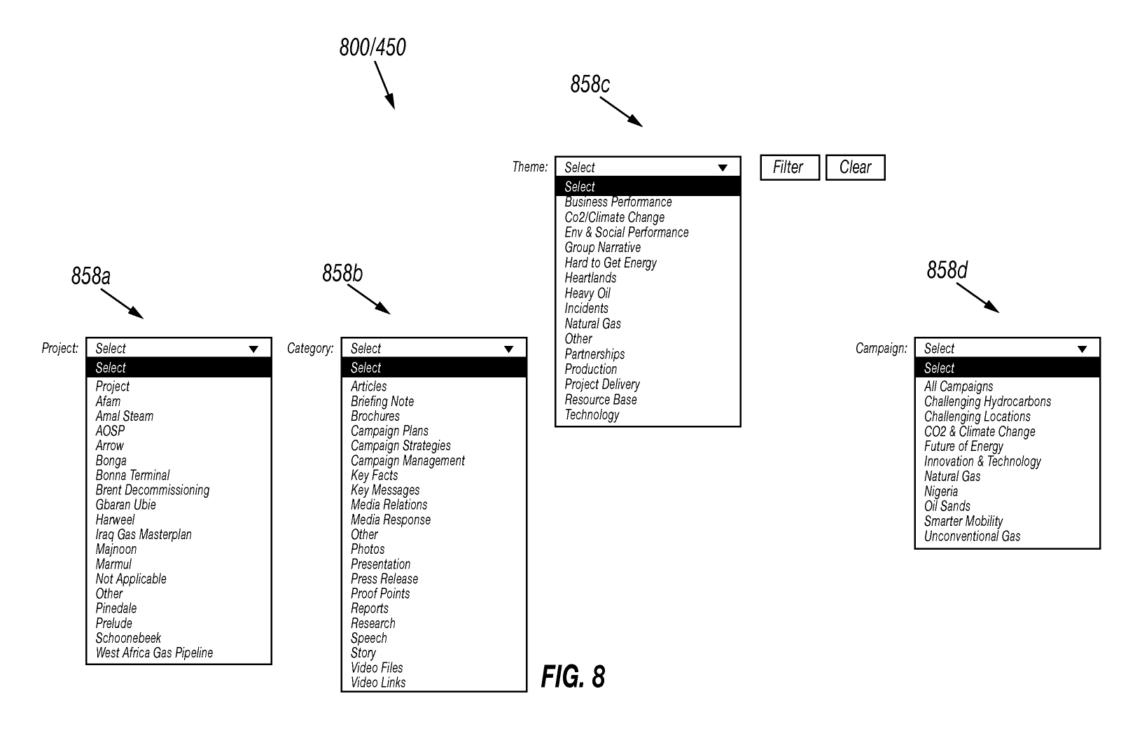

FIG. 8 shows an example of content selection 800 using the levels 450c of FIG. 4. The content retrieval 800 may be used by the user 112 to access hydrocarbon material 111″ from the matrix 104 (FIG. 3). In the format shown, the user 112 is provided with optional drop down menus for selection of the various fields 450.

As shown, the user may select from one or more of the fields 450 relating to project 858a (e.g., project), category 858b (brochure, photos, presentation, etc.), theme 858c (e.g., heavy oil, business performance, etc.), and/or campaign 858d (e.g., CO2, oil sands, natural gas, etc.) These levels 450c may be used to restrict the number of bins 444 of matrix 104 that show accessible hydrocarbon materials 111″ thereby filtering the results.

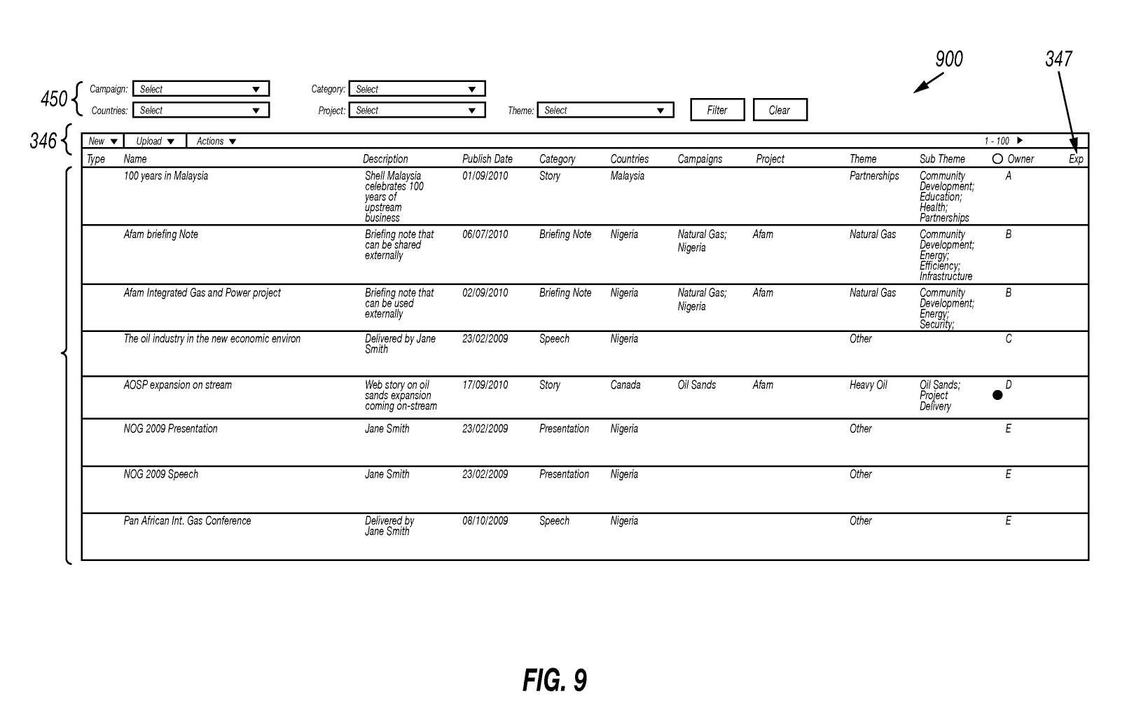

FIG. 9 depicts an example content retrieval 900 of hydrocarbon materials 111″ available in the matrix 104 of FIG. 3. As shown in this view, the hydrocarbon materials 111″ may be selected for display in the display 347.

The hydrocarbon materials 111″ may be searched by selecting the field 450 as shown in FIG. 8 and then by hovering over the available bins 444 that show hydrocarbon materials 111″ therein as shown in FIG. 5. Searches may also be performed by restricting other fields associated with the matrix 104 as shown in FIG. 3. The list of hydrocarbon materials 111″ that meet the selection criteria are displayed in the display 347 according to the criteria selected. The display may be varied to in a desired order and/or format as shown in FIG. 9. The hydrocarbon materials 111″ displayed are available for viewing and/or download using the matrix key 346.

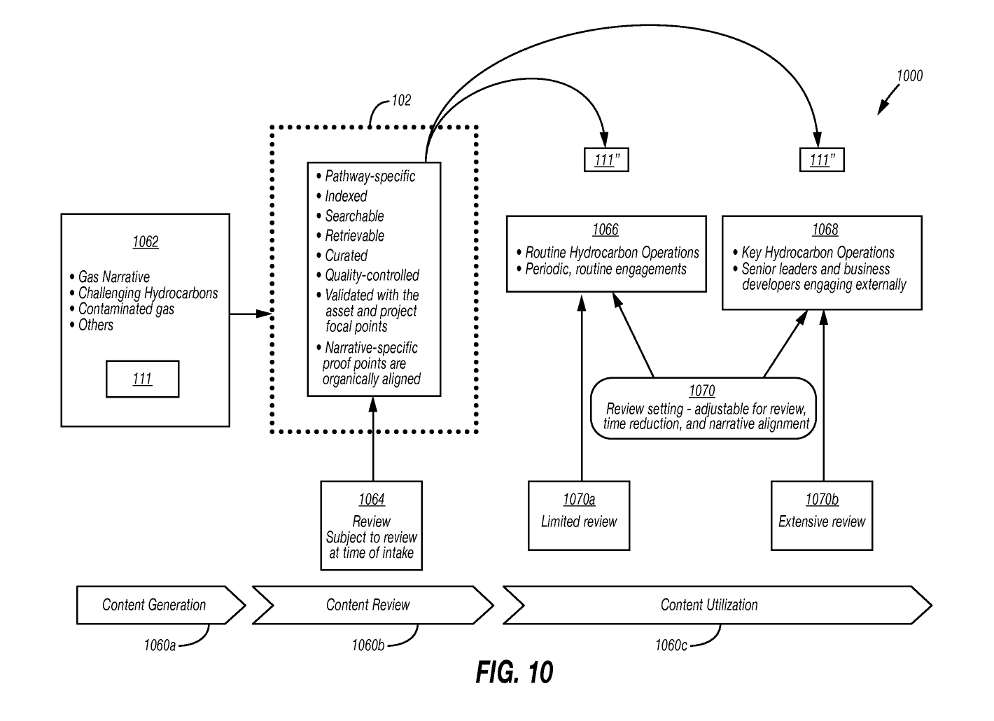

FIG. 10 provides a summary overview of a matrix operation 1000 using the matrix system 102. The matrix operation involves three basic stages, namely content generation 1060a, content review 1060b, and content utilization 1060c. As shown in this figure, in a generation stage 1060a, the matrix system 102 may be used for collecting hydrocarbon materials 111 relating to business needs as indicated by box 1062. The business needs 1062 may relate to various issues, such as gas narratives, challenging hydrocarbons, and contaminated gas. During a review stage 1060b, the matrix system 102 may be used to convert the raw hydrocarbon materials 111 into tagged and accessible hydrocarbon materials 111″ that have passed through a review process as indicated by box 1064.

By passing through the matrix system 102, the hydrocarbon materials 111″ may be provided with various features, such as pathway-specific indexed, searchable, retrievable, curated, quality-controlled, validated, and narrative specific points. The hydrocarbon materials 111″ may be validated with asset and project focal points, and narrative-specific points may be organically aligned.

As indicated by utilization stage 1060c, the hydrocarbon materials 111″ may then be used for routine hydrocarbon operations 1066 which may only require a limited review, and/or for key hydrocarbon operations 1068 that may require an extensive review (e.g., with additional reviewers 754 (FIG. 7) and/or higher accessibility criteria). The level of review may be selectively applied using a review setting 1070 to define limited review 1070a and/or extensive review 1070b and/or higher specifications as needed. Lower review may be provided to certain hydrocarbon operations 1066, 1068 to increase efficiency and/or to reduce time delays as indicated by the review setting 1070.

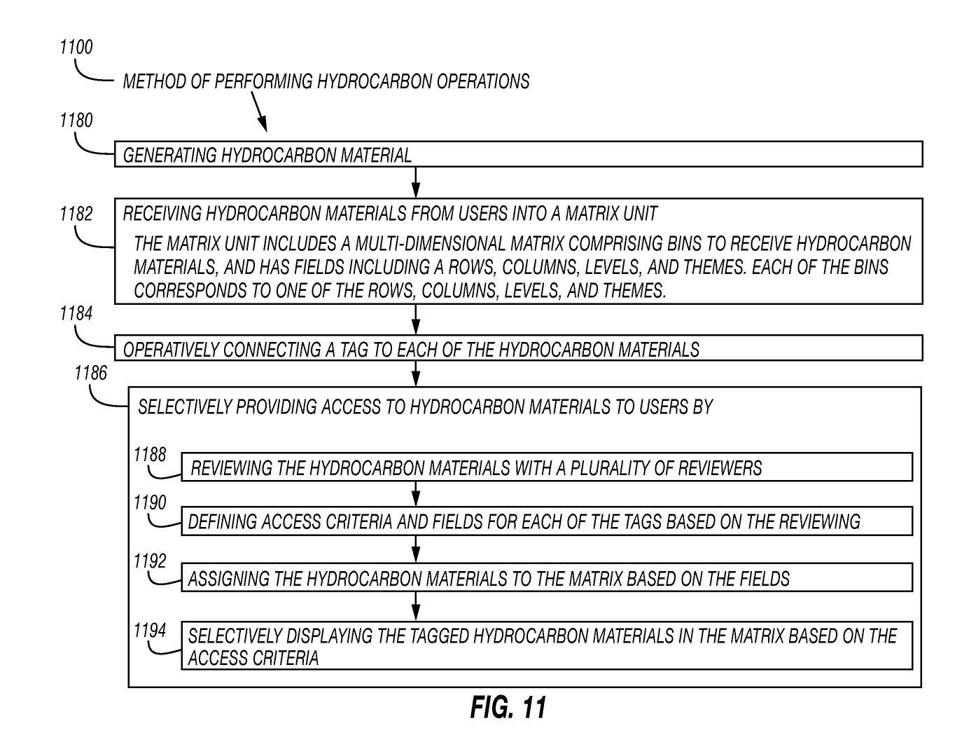

FIG. 11 is a flow chart depicting an example method 1100 of performing hydrocarbon operations 101. The method 1100 may be performed using, for example, the matrix system 102 as described herein. The method involves generating 1180 hydrocarbon material 111 (see, e.g., FIGS. 1-2C), receiving hydrocarbon materials 1182 from users into a matrix unit (see, e.g., FIG. 3). The matrix unit includes a multi-dimensional matrix comprising bins to receive hydrocarbon materials, and has fields including rows, columns, levels, and themes (see, e.g., FIGS. 4A and 4B). Each of the bins corresponds to one of the rows, columns, levels, and themes. The method 1100 also involves 1184 operatively connecting a tag to each of the hydrocarbon materials, selectively providing access 1186 to hydrocarbon materials to users. The access 1186 may be provided by reviewing 1188 the hydrocarbon materials with a plurality of reviewers, defining 1190 access criteria and fields for each of the tags based on the reviewing, assigning 1192 the hydrocarbon materials to the matrix based on the fields, and selectively displaying 1194 the tagged hydrocarbon materials in the matrix based on the access criteria.

The reviewers may include the reviewers 754 and interviewee 756, and the reviewing 1188 may involve editing the hydrocarbon materials and approving release of the hydrocarbon materials as shown, for example, in FIG. 7. The reviewing 1188 may be performed based on a review setting and define a regular review and an extended review by additional reviewers as shown, for example, in FIG. 11. The selectively displaying 1194 may involve highlighting one of the bins with a cursor and providing a list of the hydrocarbon materials in a matrix display as shown, for example, in FIGS. 5 and 9.

The method may be performed in any order, and repeated as desired.

While the embodiments are described with reference to various implementations and exploitations, it will be understood that these embodiments are illustrative and that the scope of the inventive subject matter is not limited to them. Many variations, modifications, additions and improvements are possible. For example, one or more users, reviewers, gatekeepers and/or other individuals may provide and/or access hydrocarbon materials using the matrix. The hydrocarbon materials may be tagged for placement in bins of the matrix in one or more rows, columns, levels, themes, and/or other fields.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A matrix system for performing hydrocarbon operations, the hydrocarbon operations comprising at least one of exploration, production, transportation, and delivery of hydrocarbons, the matrix system comprising:
a matrix unit comprising a multi-dimensional matrix comprising bins to receive hydrocarbon materials, the matrix having a plurality of fields, the plurality of fields comprising a plurality of rows, a plurality of columns, a plurality of levels, and a plurality of themes, each of the bins corresponding to one of the plurality of rows, one of the plurality of columns, one of the plurality of levels, and one of the plurality of themes;
at least one user terminal operatively connectable to the matrix unit, the at least one user terminal comprising a user input to upload the hydrocarbon materials to the matrix unit and a user output to receive the hydrocarbon materials from the matrix;
a tag operatively connectable to each of the hydrocarbon materials; and
a gatekeeper operatively connectable to the matrix unit, the gatekeeper comprising reviewers and a system custodian, the reviewers to review the hydrocarbon materials and to define access criteria and the plurality of fields for each of the tags, the system custodian to selectively apply the tag to the hydrocarbon materials based on the review whereby the hydrocarbon materials are selectively accessible by users.

2. The matrix system of claim 1, further comprising an activator operatively connectable to the matrix unit to selectively perform the hydrocarbon operations based on the hydrocarbon materials.

3. The matrix system of claim 1, wherein the matrix unit further comprises a display to display selected hydrocarbon materials, a matrix key to upload the hydrocarbon materials, and function keys to selectively divert the hydrocarbon materials to the user.

4. The matrix system of claim 1, further comprising a highlighter to selectively display features of a selected one of the bins upon contact between an operator cursor and pixels defining the selected one of the bins on a display.

5. The matrix system of claim 1, wherein the gatekeeper comprises a gatekeeper terminal operatively connectable to the matrix unit, the gatekeeper terminal and the at least one user terminal comprising a monitor, a keyboard, a mouse, and a processor, the at least one user terminal and the gatekeeper terminal providing access to the matrix unit via a browser.

6. The matrix system of claim 1, wherein the plurality of fields comprise regions, category, theme, campaign, and project.

7. The matrix system of claim 1, wherein the reviewers comprise at least one of an interviewee, a writer, an editor, a functional representative, a legal representative, an investor relations representative.

8. The matrix system of claim 1, further comprising a review setting defining levels of review according to types of hydrocarbon operations.

9. A method for performing hydrocarbon operations, the hydrocarbon operations comprising at least one of exploration, production, transportation, and delivery of hydrocarbons, the method comprising:
receiving hydrocarbon materials from at least one user into a matrix unit, the matrix unit comprising a multi-dimensional matrix comprising bins to receive the hydrocarbon materials, the matrix having a plurality of fields, the plurality of fields comprising a plurality of rows, a plurality of columns, a plurality of levels, and a plurality of themes, each of the bins corresponding to one of the plurality of rows, one of the plurality of columns, one of the plurality of levels, and one of the plurality of themes;
operatively connecting a tag to each of the hydrocarbon materials; and
selectively providing access to the hydrocarbon materials to users by:
reviewing the hydrocarbon materials with a plurality of reviewers;
defining access criteria and the plurality of fields for each of the tags based on the reviewing;
assigning the hydrocarbon materials to the matrix based on the plurality of fields; and
selectively displaying the tagged hydrocarbon materials in the matrix based on the access criteria.

10. The method of claim 9, wherein the plurality of reviewers comprises a writer, an editor, an interviewee, and wherein the reviewing comprises editing the hydrocarbon materials and selectively approving release of the hydrocarbon materials.

11. The method of claim 9, wherein the reviewing is performed based on a review setting defining one of a regular review the plurality of reviewers and an extended review by the plurality of reviewers and additional reviewers.

12. The method of claim 9, wherein the selectively displaying comprises highlighting one of the bins with a cursor and providing a list of the hydrocarbon materials in a matrix display.
